(19) United States
(12) Patent Application Publication
(10) Pub. No.: US 2010/0011596 A1
(43) Pub. Date: Jan. 21, 2010

(54) Hand-held band saw

(76) Inventors: Viktor Heinrichs, Untermeitingen (DE); Johannes Stempfhuber, Landsberg (DE)

Correspondence Address: ABELMAN, FRAYNE & SCHWAB, 666 THIRD AVENUE, 10TH FLOOR, NEW YORK, NY, 10017, US

(21) Appl. No.: 12/459,614

(22) Filed: Jul. 2, 2009

(30) Foreign Application Priority Data
Jul. 7, 2008 (DE) 10 2008 040 203.6

(51) Int. Cl. B23D 53/12

(52) U.S. Cl. 30/380

(57) ABSTRACT

A hand-held band saw includes a motor (13) located in a housing (11) for displacing a circumferentially closed saw band (12) displaceable between a motor-driven driving roller (14) and a deflection roller (15) arranged, respectively, in first and second saw parts (21, 22) which are connected with each other by a bracket element (20), with the saw band (12) having two band sections (121, 122) displaceable parallel to each other and next to each other in an operational region (19) located between the deflection and driving rollers (14, 15). The band sections (121, 122) define together a cut width (S), and the bracket element (20) has, in the operational region (19), a width (B) that corresponds at most to the cut width (S).

### BACKGROUND OF THE INVENTION

1. Field of the Invention

The present invention relates to a hand-held band saw including a first saw part with a driving roller, a second saw part with a deflection roller and fixedly connected with the first saw part, a housing, a motor located in the housing for driving the driving roller, and a circumferentially closed saw band displaceable between the driving roller and the deflection roller and having at least one band section freely displaceable in an operational region located between the driving roller and the deflection roller.

2. Description of the Prior Art

Band saws of the type described above have a saw band displaceable during operation of the saw in an operational region, which is called a saw gap, e.g., for producing cuts in workpieces.

Japanese Publication JP-20000-42949 discloses a band saw having a motor located in a housing for driving a circumferentially closed saw band. The saw band is displaced between a motor-driven driving roller and a deflection roller and has a band section that is guided in an operational region between the driving roller and the deflection roller in an exposed state.

In the rear region, with respect to the operational region, there is provided a housing region that connects a first housing part with the deflection roller with a second housing part with the driving roller and in which the saw band is returned back.

The drawback of the band saw disclosed in JP 2000042 949 consists in that the housing guided behind the saw band in the operational region, limits the cut depth.

Accordingly, an object of the present invention is to provide a hand-held saw that permits to produce bigger cut depth.

### SUMMARY OF THE INVENTION

This and other objects of the present invention, which will become apparent hereinafter, are achieved by providing a second band section displaceable parallel to and next to the at least one band section in the operational region, with both, displaceable next to each other in the operational region, band sections defining a cut width, and by providing a bracket element for connecting the first saw part with the driving roller and the second saw part with the bracket element and having, at least in one of its sections along the operational region (parallel to the cut width), a width that at most corresponds to the cut width in the operational region. Thereby, the saw band can be driven in the operational region in both opposite directions from the driving roller to the deflection roller and from the deflection roller to the driving roller.

The novel features of the present invention insure that, at large cut depth, the bracket element can be displaced into a saw gap which is produced by displaceable, in the operational region, parallel to each other and next to each other, band sections of the saw band, and can follow the saw band. In this way, any cut depth can be obtained.

Advantageously, there are provided, at both, in the band direction, ends of the operational region, two pairs of tensioning rollers, respectively, which provide for joint displacement of both band sections of the saw band in the operational region. Thereby, in a simple manner, displacement of located next to each other, band sections, with a narrow gap therebetween, is achieved.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a hand-held band saw according to the present invention;

FIG. 2 a view of the hand-held band saw in direction of arrow II in FIG. 1; and

FIG. 3 a view of a detail of the band saw marked by numeral III in FIG. 2.

### DETAILED DESCRIPTION OF THE PREFERRED EMBODIMENT

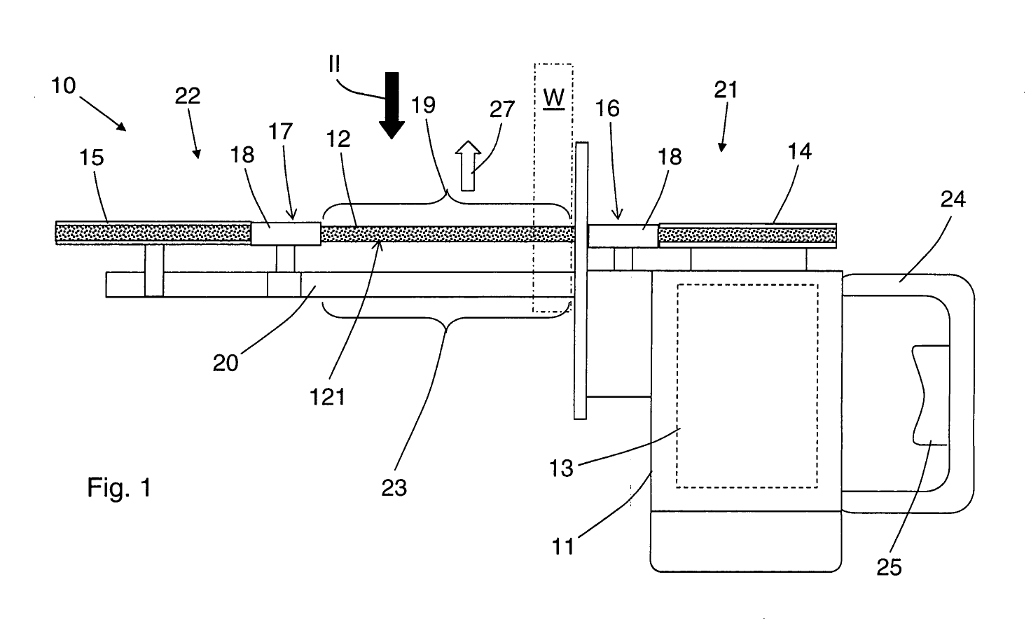

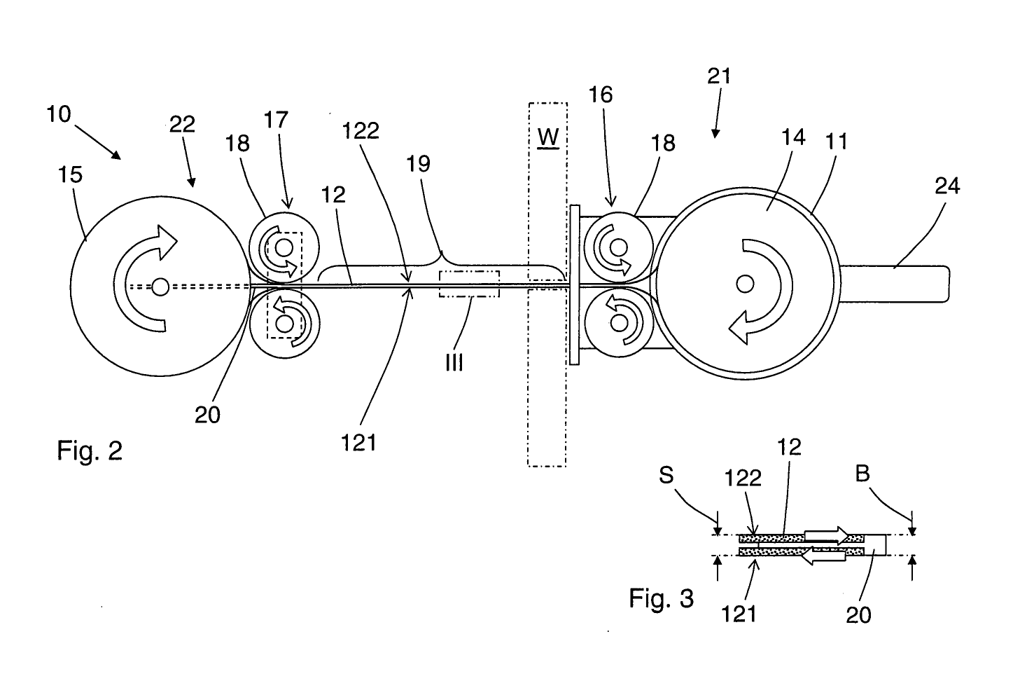

A band saw 10 according to the present invention, which is shown in FIGS. 1 through 3, has a rope- or band-shaped saw band 12 for cutting workpieces W, and a motor 13 for driving the saw band 12 and located in a housing 11. The band saw 10 has a first saw part 21 that includes the housing 11, together with the motor 13 located therein, a motor-driven driving roller 14 (a rotational direction of which during operation of the band saw 10, is shown with an arrow), and a first pair 16 of tensioning rollers 18. The first part 21 also includes a guide plate 26 which is placed on a workpiece W (shown in FIGS. 1 and 2 with dash-dot lines). The band saw 10 also has at least one handle 24 with a switch 25 provided thereon for actuating the band saw 10.

A bar-shaped bracket element 20 connects the first saw part 21 with a second saw part 22. The second saw part 22 includes a deflection roller 15 and a second pair 17 of tensioning rollers 18 for the saw band 12. The second pair 17 of tensioning rollers 18 is provided at an end region of the bracket element 20.

The deflection roller 15 and the tensioning rollers 18 of both pairs 16 and 17 are supported by journals for a free rotation thereabout. During operation of the band saw 10, the deflection roller 15 and the tensioning rollers 18 rotate in directions shown with arrows in FIG. 2. Exactly opposite rotational directions of the deflection roller 15 and the tensioning rollers 18 are likewise possible.

In an operational region 19, there are located, in the extension direction of the saw band 12, between the second pair 17 of the tensioning rollers 18 and the guide plate 26, a first band section 121 and a second band section 122 of the saw band 12. The band sections 121, 122 are freely displaceable in order to be able to make cuts in a workpiece W. The band sections 121, 122 run parallel to each other between the tensioning roller 18 and are guided in the operational region 19 next to each other. The band sections 121, 122 define together a cut width S, as can be seen in FIG. 3. The bracket element 20 that lies, in a cut direction 27, behind the saw band 12, has a width B in a section 23 along the operational region 19 (see FIG. 3). The width B at most corresponds to the cut width S in the operational region 19.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held band saw, comprising a first saw part (21) including a driving roller (14); a second saw part (22) including a deflection roller (15); a housing (11); a motor (13) located in the housing (11) for driving the driving roller (14); a bracket element (20) for connecting the first saw part (21) with the second saw part (22); and a circumferentially closed saw band (12) displaceable between the driving roller (14) and the deflection roller (15) and having a first band section (121) and a second band section (122) displaceable parallel to each other and next to each other in an operational region (19) located between the driving roller (14) and the deflection roller (15), the first and second band sections (121, 122) defining a cut width (S), and the bracket element (20) having, at least in one section (23) thereof along the operational region (19), a width (B) that at most corresponds to the cut width(S) in the operational region (19).

2. A band saw according to claim 1, further comprising two pairs (16, 17) of tensioning rollers (18) located, respectively, at both ends of the operational region (19) in a direction of a band extension, the two pairs (16, 17) of tensioning rollers (18) providing for joint displacement of the first and second band sections (121, 122) of the saw band (12).
